(19) United States
(12) Patent Application Publication
(10) Pub. No.: US 2010/0062261 A1
(43) Pub. Date: Mar. 11, 2010

(54) Complex with separated scintillator and photocatalyst and manufacturing method thereof

(76) Inventors: Chih-Ching CHANG, Longtan Township (TW); Yih-Ping CHEN, Longtan Township (TW)

Correspondence Address: SINORICA, LLC, 2275 Research Blvd., Suite 500, ROCKVILLE, MD, 20850, US

(21) Appl. No.: 12/207,491

(22) Filed: Sep. 9, 2008

(51) Int. Cl. B32B 17/06; B32B 9/04; B05D 5/00

(52) U.S. Cl. 428/426; 428/691; 428/697; 428/698; 428/702; 427/209

(57) ABSTRACT

A complex with separated scintillator and photocatalyst and a manufacturing method thereof are disclosed. The complex with separated scintillator and photocatalyst includes a transparent substrate, a scintillantor layer on one side of the substrate, and a photocatalyst layer on the other side of the substrate. The manufacturing method of the complex consists of the following steps: depositing photocatalyst on one side of a transparent substrate, depositing scintillator on the other side of the transparent substrate, and sintering the transparent substrate with coatings to form a complex with separated scintillator and photocatalyst. Thus the present invention prevents the lowering of photocatalytic performance caused by contact of scintillator with photocatalyst and can be applied to produce large-area photocatalytic reactors easily.

### BACKGROUND OF THE INVENTION

The present invention relates to a composite photocatalyst, especially to a complex having separated scintillator and photocatalyst that is applied to improve photocatalytic performance of radiant-energy type composite photocatalyst and degrade pollutants.

The photocatalyst is a kind of semiconductor materials, such as titanium dioxide (TiO₂), cadmium sulfide (CdS), and zirconium oxide (ZrO₂) that converts light energy and performs photocatalytic reaction. The electron orbital of these materials includes valence band and conduction band. The energy gap between the valence band and the conduction band is referred to as the band gap. When the photocatalyst absorbs light with certain wavelength, electrons are excited to the conduction band from the valence band, leaving behind holes that are considered having substantial oxidizing power. However, photocatalytic reaction would not proceed when the excited electrons recombine with the holes. Different from conductors, semiconductors have discrete energy levels which do not favor the recombination of electrons and holes. Hence, lifetime of the electron/hole is extended. Therefore, when the photocatalyst is excited by light, the generated electrons and holes that move to the surface of the photocatalyst will reduce electron acceptors and oxidize electron donors that are exposed to the photocatalyst as the photocatalytic reaction occurs.

The transferability of the electrons and holes are closely related to the band edge of the valence band as well as the conduction band of the photocatalysts and oxidation/reduction potential of materials that are adsorbed on the photocatalyst surface. If the reactant molecule has already been adsorbed on the surface of the photocatalyst, the transfer process will become more effective, and so is the photocatalytic activity.

Similar to semiconductors, when absorbing radiation energy, scintillators are excited to give off electrons/holes. As electrons recombine with holes, they will produce some light photons of specific wavelength which are capable of exciting the photocatalyst. Referred to Taiwanese Pub. No. 200603882, a radiant-energy type photocatalytic complex 1 is disclosed. In the patent, porous materials such as ceramic powder 11 are used as carrier where photocatalyst 13 as well as scintillator 12 is modified thereon and well-mixed through the process of impregnation, as shown in FIG. 1. However, Mixing and contact of the scintillator 12 with the photocatalyst 13 will create a problem in controlling the movement of the electrons and holes after excited by ionizing radiation. Furthermore, after the photocatalytic reaction, elaborate separation process for removing reactants from the products is required, which is also a shortcoming of the technique in the prior art.

Since the energy of the ionizing radiation is much higher than the bandgap of the photocatalyst as well as the scintillator, electrons and holes are generated both in the photocatalyst and scintillator under ionizing radiation. Under such a condition, they will tend to move between the photocatalyst and the scintillator, which may diminish the rate of photocatalytic reaction.

Since most photocatalytic reactions are conducted under aqueous solution, water receiving ionizing radiation may dissociate into hydrated electrons (e⁻_{aq}), hydrogen atoms known as the reductant and hydroxyl radical (OH), etc. At the same time, holes generated by the photocatalyst in the aqueous solution after irradiated by ionizing radiation also react with water molecules adsorbed on surface to generate hydroxyl radicals that are needed for the oxidation reaction. If there are too many reductants reacting with hydroxyl radicals in the reaction environment, the reaction rate of the photocatalytic oxidation will be reduced. In general, electron scavengers such as, oxygen, can be added to solve this problem.

A transparent substrate coated uniformly with scintillator on one side and photocatalyst on the other is provided as to prevent lowering of reaction rate of the photocatalysis caused by contact between the scintillator and photocatalyst for manufacturing large-area photocatalytic reactors. Moreover, reactants and products can be removed and separated easily after the completion of photocatalyic reaction. Thus, the complex with separated scintillator and photocatalyst can be recycled.

The transparent substrate used as carrier can also be a conductive substrate that is applied with a voltage or a grounding device for preventing the accumulation of electrons during photoreaction. Thus the recombination probability of the electrons and holes is reduced and the holes are likely to react with reactants. Therefore, the performance of photocatalysis is improved.

### SUMMARY OF THE INVENTION

Therefore it is a primary object of the present invention to provide a complex having separated scintillator and photocatalyst and a manufacturing method thereof that prevent the lowering of photocatalytic efficiency caused by contact between the scintillator and photocatalyst for manufacturing large-area photocatalytic reactors. Moreover, reactants and products are removed and separated easily after the completion of photocatalytic reaction so that the complex with separated scintillator and photocatalyst can be recycled.

It is another object of the present invention to provide a complex having separated scintillator and photocatalyst and a manufacturing method thereof that use a transparent conductive substrate applied with a bias or a grounding device for preventing the accumulation of electrons during photoreaction. Thus the recombination probability of the electrons and holes is reduced and the holes are likely to react with reactants. Therefore, the performance of photocatalysis is improved.

A complex having separated scintillator and photocatalyst according to the present invention includes a transparent substrate, a scintillantor layer on one side of the substrate, and a photocatalyst layer on the other side of the substrate. A manufacturing method of the complex consists of the following steps: depositing photocatalyst on one side of a transparent substrate, depositing scintillator on the other side of the transparent substrate and sintering the transparent substrate to form a complex with separated scintillator and photocatalyst.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a schematic drawing showing how photocatalyst and scintillator contact with each other in an impregnation method of a prior art;

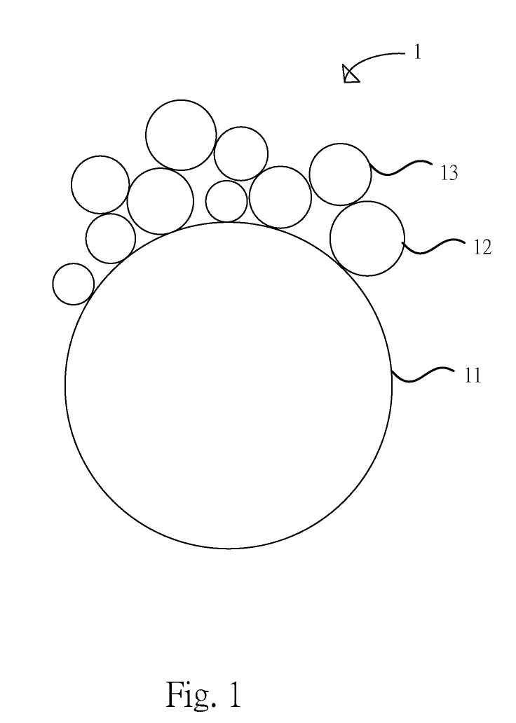

FIG. 2 is a schematic drawing showing structure of an embodiment of a complex having separated scintillator and photocatalyst according to the present invention;

FIG. 3 is a flow chart showing manufacturing processes of the embodiment according to the present invention.

### DETAILED DESCRIPTION OF THE PROFFERED EMBODIMENT

After irradiated by ionizing radiation, electrons and holes created in the scintillator may recombine together to emit light. Similarly, electrons and holes are generated in photocatalyst under ionizing radiation. The electrons and holes in the two materials tend to move to the low energy level, may transfer to the other material and recombines if the photocatalyst is exposed to the scintillator. Thus the photocatalysis efficiency is reduced. Therefore, a main point of the present invention is to prevent transfer of electrons and holes between the scintillator and the photocatalyst by means of a transparent substrate. By applying a bias or a grounding device for conducting electrons generated during the photoreaction, the recombination probability of the electrons and holes is reduced. Therefore, the performance of photocatalysis is improved.

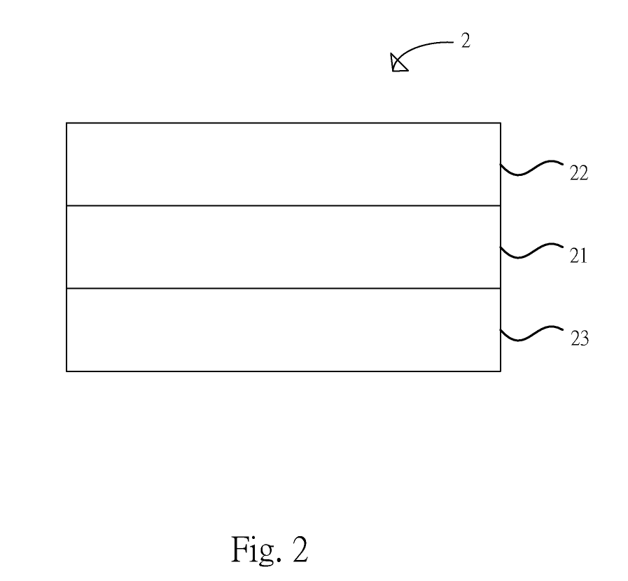

Referred to FIG. 2, a complex with separated scintillator and photocatalyst according to the present invention includes a transparent substrate, a scintillantor layer on one side of the substrate, and a photocatalyst layer on the other side of the substrate.

The substrate is made from quartz glass or other transparent material. The substrate can also be a transparent conductive substrate that is applied with a bias or a grounding device for conducting electrons generated during photoreaction so as to improve photocatalysis efficiency. The transparent conductive substrate is made of indium tin oxide (ITO) or other transparent conductive material.

The scintillantor layer is a nano-scale scintillantor layer and is made of sodium iodide, cesium iodide, barium fluoride, cerium fluoride, or yttrium aluminum perovskite (YAP) and etc.

The photocatalyst layer is a nano-scale photocatalyst layer and is made of titanium dioxide, zinc oxide, tungsten oxide, zirconium oxide or cadmium sulfide and etc.

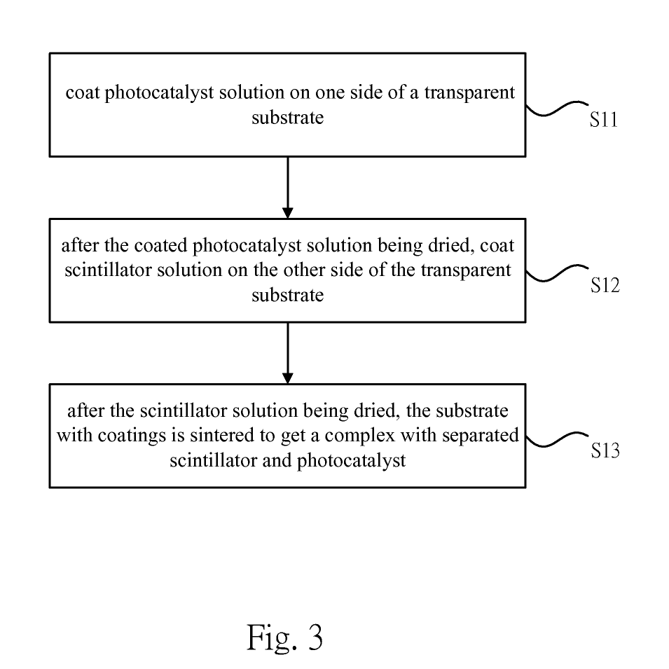

Refer to FIG. 3, a manufacturing method of complex with separated scintillator and photocatalyst according to the present invention includes the following steps: S11, S12, S13.

In step S11, the photocatalyst is a nano-scale photocatalyst. Step S11 further includes a step of preparing the nano-scale photocatalyst by a sol-gel method. The nano-scale photocatalyst is selected from one of the following materials: titanium dioxide, zinc oxide, tungsten oxide, zirconium oxide and cadmium sulfide.

In step S12, the scintillator is a nano-scale scintillator. The nano-scale scintillator is selected from one of the following materials: sodium iodide, cesium iodide, barium fluoride, cerium fluoride, or yttrium aluminum perovskite (YAP).

In step S13, the temperature of sintering ranges from 450 degrees Celsius to 600 degrees Celsius and the sintering time ranges from 1 to 4 hours.

### Embodiment One

Firstly, a solution with nano-scale titanium dioxide is prepared by a sol gel method. Then the solution is applied to one side of quartz glass. After drying, a solution containing barium fluoride granules is applied to the other side of the quartz glass. After drying, the quartz glass is sent into a furnace for sintering at 550 degrees Celsius for 2 hours so as to obtain a complex with separated scintillator and photocatalyst.

### Embodiment Two

A solution with nano-scale titanium dioxide by a sol gel method is applied to one side of an indium tin oxide (ITO) substrate. After drying, a solution containing barium fluoride granules is applied to the other side of the substrate. After drying, the substrate is sent into a furnace for sintering at 550 degrees Celsius for 2 hours so as to obtain a complex with separated scintillator and photocatalyst.

The following experiments show advantages of the embodiment according to the present invention:

Refer to table 1: Photocatalytic degradation of methylene-blue by various composite photocatalyst such as barium fluoride (BaF₂), titanium dioxide (ISK ST-01) and CCC-1 to CCC-6 containing mixture of barium fluoride (BaF₂) and titanium dioxide (ISK ST-01) respectively are shown.

TABLE 1
Photocatalytic degradation of methylene-blue under ionizing
radiation:

| | | | Amount of titanium | |
|---|---|---|---|---|
| | | | dioxide in | Photocatalytic |
| | | Degradation | composite | activity per unit |
| No. | Catalyst | ratio (%) | photocatalyst (%) | weight |
| 1 | CCC-1 | 42 | 98 | 42.85 |
| 2 | CCC-2 | 32 | 90 | 35.5 |
| 3 | CCC-3 | 23 | 50 | 46 |
| 4 | CCC-4 | 21 | 25 | 84 |
| 5 | CCC-5 | 27 | 10 | 270 |
| 6 | CCC-6 | 19 | 5 | 380 |
| 7 | 100 mg | 53 | — | 53 |
| | ST-01 | | | |
| 8 | 75 mg ST-01 | 47 | — | 63 |
| 9 | 50 mg ST-01 | 40 | — | 80 |
| 10 | 10 mg ST-01 | 32 | — | 320 |
| 11 | 5 mg ST-01 | 16 | — | 320 |
| 12 | 100 mg BaF₂ | 12 | — | — |
| 13 | 95 mg BaF₂ | 13 | — | — |
| 14 | 50 mg BaF₂ | 15 | — | — |
| 15 | 25 mg BaF₂ | 14 | — | — |
| 16 | 10 mg BaF₂ | 13 | — | — |

In the experiment, the degradation ratio of each composite photocatalyst (CCC-1˜CCC-6) is compared with a sum of the degradation ratio of specific weight of BaF2, and the degradation ratio of specific weight of ISK ST-01. The degradation ratios are different from each other. For example, CCC-3 contains 50 mg ISK ST-01 (titanium dioxide) and 50 mg BaF₂ (barium fluoride). Add the degradation ratio of item No. 9 and that of item No. 14 to get the sum of 55%. In fact, the degradation ratio of CCC-3 is only 23%. Similarly, add the degradation ratio of item No. 11 and that of item No. 13 to get the ratio of 29% while degradation ratio of CCC-6 having 5 mg ISK ST-01 and 95 mg barium fluoride is 19%.

Therefore, the results show that the transfer of electrons and holes may occur between barium fluoride and titanium dioxide which favors the recombination probability of electrons and holes. As a result, the photocatalytic activity is reduced. Since the bandgap of barium fluoride and that of titanium dioxide are much smaller than energy of ionizing radiation, electron-hole pairs are generated easily under ionizing radiation. Once the lifetime of the electrons and holes is extended, the photocatalytic activity will be improved. Accumulation of electrons will increase the recombination probability of electrons and holes, which is detrimental for the oxidation/reduction reactions. The results prove that the performance of the photocatalyst is poorer when barium fluoride is exposed to titanium dioxide.

Furthermore, deposit TiO₂ solution and BaF₂ on two sides of the quartz glass to form a sandwich-type composite photocatalyst and examine its performance from the degradation of the methylene-blue. The performance of the photocatlyst is compared with that having a quartz glass deposited with titanium dioxide only. From table 2, the degradation ratio of the methylene-blue by the sandwich-type composite photocatalyst is about 35% higher than that of the quartz deposited with titanium dioxide only.

TABLE 2
Degradation of methylene-blue under ionizing irradiation

| | Degradation ratio (%) |
|---|---|
| Quartz plate coated TiO₂ | 17.9 |
| Quartz plate coated TiO₂ and BaF₂ | 24.3 |

(condition: 100 ml 10 ppm methylene-blue solution after ⁶⁰Co irradiation for 3 days)

In summary, a complex with separated scintillator and photocatalyst and a manufacturing method thereof have following advantages:
1. The disadvantage of the lowering of photocatalytic performance in a conventional impregnation method caused by contact of scintillator and photocatalyst modified on ceramic powder is resolved.
2. By the present invention, a large-area photocatalytic reactor can be produced easily.
3. After completion of the photoreaction, reactants are easily removed from products so that the complex having separated scintillator and photocatalyst can be recycled.
4. The present invention further use a transparent conductive substrate that is applied with a bias or a grounding device for conducting electrons during photocatalytic reaction so as to reduce recombination probability of electrons and holes and increase reaction probability of holes with reactants. Therefore, the performance of photocatalytic reaction is improved.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. A complex with separated scintillator and photocatalyst comprising:
a transparent substrate;
a scintillator layer on one side of the substrate;
and a photocatalyst layer on the other side of the substrate.

2. The complex as claimed in claim 1, wherein the transparent substrate is made of quartz glass.

3. The complex as claimed in claim 1, wherein the transparent substrate is a transparent conductive substrate.

4. The complex as claimed in claim 3, wherein the transparent conductive substrate is made of indium tin oxide (ITO).

5. The complex as claimed in claim 1, wherein the scintillantor layer is a nano-scale scintillantor layer, made of scintillator materials that can absorb radiation energy and emit photons to excite photocatalyst to perform photocatalytic reaction.

6. The complex as claimed in claim 5, wherein the nano-scale scintillantor material is made of sodium iodide, cesium iodide, barium fluoride, cerium fluoride, or yttrium aluminum perovskite (YAP).

7. The complex as claimed in claim 1, wherein the photocatalyst layer is a nano-scale photocatalyst layer.

8. The complex as claimed in claim 7, wherein the nano-scale photocatalyst layer is made of titanium dioxide, zinc oxide, tungsten oxide, zirconium oxide or cadmium sulfide.

9. A manufacturing method of complex with separated scintillator and photocatalyst comprising the steps of:
depositing photocatalyst solution on one side of a transparent substrate;
depositing scintillator solution on the other side of the transparent substrate;
and sintering the transparent substrate with coatings to form a complex with separated scintillator and photocatalyst.

10. The method as claimed in claim 9, wherein in the step of depositing photocatalyst on one side of a transparent substrate, the photocatalyst is a nano-scale photocatalyst.

11. The method as claimed in claim 10, wherein the step of depositing photocatalyst on one side of a transparent substrate further comprising a step of preparing the nano-scale photocatalyst by a sol-gel method.

12. The method as claimed in claim 10, wherein nano-scale photocatalyst is titanium dioxide, zinc oxide, tungsten oxide, zirconium oxide or cadmium sulfide.

13. The method as claimed in claim 9, wherein in the step of depositing scintillator on the other side of the transparent substrate, the scintillator is a nano-scale scintillantor.

14. The method as claimed in claim 13, wherein nano-scale scintillantor is made of sodium iodide, cesium iodide, barium fluoride, cerium fluoride, or yttrium aluminum perovskite (YAP).

15. The method as claimed in claim 9, wherein in the step of sintering the transparent substrate with coatings to form a complex with separated scintillator and photocatalyst, at sintering temperature ranges from 450 to 600 degrees Celsius and sintering time ranges from 1 to 4 hours.

16. The method as claimed in claim 9, wherein in the step of depositing photocatalyst on one side of a transparent substrate, the transparent substrate is a transparent conductive substrate.
